(19) United States
(12) Patent Application Publication
(10) Pub. No.: US 2014/0247624 A1
(43) Pub. Date: Sep. 4, 2014

(54) PASSIVELY SWITCHED CONVERTER AND CIRCUITS INCLUDING SAME

(71) Applicant: Auckland UniServices Limited, Auckland (NZ)

(72) Inventors: Iain Alexander Anderson, Auckland (NZ); Todd Alan Gisby, North Shore City (NZ); Ho Cheong Lo, Auckland (NZ); Thomas Gregory McKay, Auckland (NZ); Benjamin Marc O'Brien, Auckland (NZ)

(73) Assignee: AUCKLAND UNISERVICES LIMITED, Auckland (NZ)

(21) Appl. No.: 14/351,299

(22) PCT Filed: Oct. 15, 2012
(86) PCT No.: PCT/NZ2012/000187

§ 371 Date: Apr. 11, 2014

(30) Foreign Application Priority Data
Oct. 14, 2011 (NZ) 595772

(51) Int. Cl. H02M 3/24

(52) U.S. Cl. CPC H02M 3/24
USPC 363/15

(57) ABSTRACT

The invention provides a passive converter comprising an input for electrical coupling to an intermittent or variable power source, an output for electrical coupling to load, and a conversion circuit for converting from a first voltage level of the input to a second voltage level suitable for the output, wherein the conversion circuit includes a passive switching circuit adapted to passively couple the input to the output when the input exceeds a first threshold and decouple the input from the output when the input falls below a second threshold. In particular, the passive switching circuit preferably comprises a spark gap, thyristor and avalanche diode, breakover diode, discharge tube, or a thyristor operated as breakover diodes. Circuits and dielectric elastomer generator (DEG) systems including the passive converter are also disclosed.

### FIELD OF THE INVENTION

This invention relates to a converter circuit for transferring electrical energy to/from an intermittent DC voltage source to an electrical circuit that may or may not operate at a different voltage. In particular, the invention relates to a passively-switched converter and circuits or systems including the same, and more particularly circuits further comprising a dielectric elastomer generator (DEG).

### BACKGROUND

Conventional DC-DC converters of the prior art typically use active control to produce an output voltage or current of a desired magnitude, most commonly within two orders of magnitude higher or lower than an input voltage or current. Buck converters, boost converters, and/or buck-boost converters are all examples of a class of converters commonly referred to as “switched-mode” power supplies which are actively controlled to regulate the output. As shown diagrammatically in FIG. 2, these active converters 20 typically use sensor 21, controller 22, and driver electronics 23 which increase the size, cost, and complexity of the circuit. Also, a low voltage power source 24 is required to power these electronics. Other converters of the prior art including flyback, forward, and H-bridge converters have similar requirements.

While the DC-DC converters of the prior art are suitable for many applications requiring DC voltage conversion, there are other applications in which active control may be undesirable. Reasons include, but are not limited to, cost, form factor, complexity, efficiency, and/or availability of technology.

Dielectric elastomer generators (DEGs), for example, are a high-voltage, limited energy, low-power source. DEGs are a type of energy harvester or generator capable of converting mechanical energy to electrical energy, closely related to dielectric elastomer actuators (DEAs) which perform the reverse function of converting electric energy to mechanical energy.

The advantageous properties of DEGs compared to prior art alternatives such as piezoelectric generators include softness, flexibility, light weight, low cost, capability of achieving large strains, and an ability to operate without loss in performance over a large range of mechanical stroke frequencies. Effectively utilising these properties requires careful selection of the necessary accompanying electronics.

A DEG is composed of a thin (in relation to its planar area) and resilient dielectric elastomer membrane with compliant electrodes on opposing sides. In effect, the DEG is a variable capacitor, and its capacitance changes with mechanical strain (i.e. deformation of the membrane). The DEG generates electrical energy by increasing the electric potential energy stored in it. The steps to achieve this are illustrated diagrammatically in FIG. 1. Starting from the top of FIG. 1, mechanical energy 10 is initially applied to the DEG 11 by stretching it. This results in a planar expansion of electrodes 12 and an orthogonal compression of the membrane 13, leading to an increased capacitance. Electrical energy 14 is then input to the DEG by charging or priming from an electric power source (not shown) so that opposing electrodes 12 become oppositely charged. Relaxing the DEG will convert the mechanical energy into electrical energy by forcing apart the opposite charges (+ and −) on opposing electrodes 12, and forcing the like charges on each electrode 12 closer together due to the planar contraction thereof. The electrical energy 14 is extracted and the cycle repeats.

DEG are generally operated at high voltages (typically a few kilovolts) to increase power generation. A converter for use with a DEG may therefore be required to:

a) convert a low voltage (e.g. supplied by a battery) to a high voltage to prime the DEG;

b) convert the high voltage power generated by the DEG into a lower voltage form for use by an external circuit (e.g. to charge the battery and/or power typical electronic devices which generally operate on voltages of 12V or below); and/or

c) prevent the DEG voltage from rising too high to avoid damaging the DEG through dielectric breakdown.

The use of active converters may in some cases be appropriate for large scale DEG systems (i.e. comprising a plurality of energy harvesting DEGs) but they are impractical for conversion in small-scale DEGs (such as a shoe heel generator), which are high-voltage (typically operating at 500V or more), limited-energy, low-power sources, because:
active high-voltage components are relatively large and expensive, and it would be costly to convert such a small amount of power;
typical high-voltage sensors often have a significant amount of leakage current and may dissipate a significant proportion of the energy generated;
the active electronics consume power during periods where there is no input power for conversion (i.e. when there is no mechanical force being applied to the DEG); and
the active electronics may consume more power than the DEG is capable of producing.

A converter for such small-scale DEG should therefore ideally be small in size, light weight, low cost, require little or no power to operate in converting power in at least one direction. Where the power source provides a small amount of energy that is replenished intermittently, like the high-voltage energy stored in the capacitance of a DEG, for example, active converters may be impractical.

### OBJECT OF THE INVENTION

It is therefore an object of the invention to provide a converter which overcomes or at least ameliorates one or more disadvantages of the prior art, or alternatively to at least provide the public with a useful choice.

Further objects of the invention will become apparent from the following description.

### SUMMARY OF INVENTION

Accordingly, in a first aspect the invention may broadly be said to consist in a passive converter comprising an input for electrical coupling to an intermittent or variable power source, an output for electrical coupling to load, and a conversion circuit for converting from a first voltage level of the input to a second voltage level suitable for the output, wherein the conversion circuit includes a passive switching circuit adapted to passively couple the input to the output when the input exceeds a first threshold.

Preferably the switching circuit is further adapted to decouple the input from the output when the input falls below a second threshold.

Preferably the first threshold comprises a threshold voltage, and the second threshold comprises a threshold current.

Preferably the converter comprises a step-down converter, wherein the first voltage exceeds the second voltage.

Alternatively, the converter may comprise a step-up converter, wherein the second voltage exceeds the first voltage.

Alternatively, the converter may comprise a 1:1 converter, wherein the second voltage is the same as the first voltage.

Preferably the conversion circuit further comprises a transformer coupling the passive switching circuit to the output. In particular, the passive switching circuit preferably couples the input to a primary winding of the transformer when the input exceeds the threshold voltage, and the secondary winding of the transformer is coupled to the output.

Preferably the secondary winding of the transformer is coupled to the output via a diode.

Alternatively, the secondary winding of the transformer may be coupled to the output via a full-wave rectifier.

Alternatively, the secondary winding of the transformer may comprise a centre-tapped winding comprising first and second half windings, wherein said first and second half-windings are coupled to the output via a pair of diodes forming a full-wave centre-tapped rectifier.

Alternatively, the conversion circuit may further comprise an inductor circuit coupling the passive switching circuit to the output.

Preferably the inductor circuit further comprises a freewheeling diode.

Preferably the inductor circuit further comprises a reverse blocking diode.

Preferably the switching circuit comprises a spark gap, whereby the first threshold comprises a breakdown voltage of the spark gap, and the second threshold comprises a holding current of the spark gap.

Alternatively, the switching circuit may comprise a thyristor in series with a primary winding of the transformer, and an avalanche diode connected between a positive terminal of the input and the gate of the thyristor, whereby the first threshold comprises a breakdown voltage of the avalanche diode and the second threshold comprises a holding current of the thyristor.

Alternatively, the switching circuit may comprise a breakover diode coupled with an inductor and a bypass diode, whereby the first threshold comprises a breakover voltage and the second threshold comprises a holding current of the breakover diode.

Alternatively, the switching circuit may comprise a component selected from the group comprising spark gaps, thyristors and avalanche diodes, breakover diodes, discharge tubes, and thyristors operated as breakover diodes.

Preferably the converter further comprises a buffer circuit between the input and the conversion circuit.

Preferably said buffer circuit comprises an RC network.

In a second aspect, the invention may broadly be said to consist in a bi-directional converter comprising a passive converter for converting power in a first direction, and an active converter for converting power in a second, opposing, direction. In particular, the passive converter preferably comprises a passive converter according to the first aspect of the invention.

Preferably the bi-directional converter further comprises a rectifier associated with the active converter. The rectifier preferably comprises a voltage multiplier, and in particular a Greinacher voltage doubling rectifier.

Preferably the bi-directional converter further comprises a transformer associated with both the passive and active converters.

Preferably the active converter comprises a flyback converter.

Preferably the passive converter comprises a step-down converter, and the active converter comprises a step-up converter.

In a third aspect, the invention may broadly be said to consist in a dielectric elastomer generator (DEG) system comprising a DEG electrically coupled to a passive converter according to the first aspect of the invention.

Preferably the DEG system comprises two passive converters and two pairs of DEGs adapted to operate in counter phase, wherein each pair of DEGs is provided in series and coupled to the input of one of said passive converters and each pair of DEGs are coupled to each other by an inductor and a pair of breakover diodes.

Preferably the passive converters each comprise a breakover diode as the passive switching circuit.

Preferably the output of the passive converters is coupled to a capacitor, battery, or resistor.

In a fourth aspect, the invention may broadly be said to consist in a dielectric elastomer generator (DEG) system comprising a DEG electrically coupled to a bi-directional converter according to the second aspect of the invention.

Preferably the DEG system further comprises a self-priming circuit in parallel with the DEG and bi-directional converter.

Further aspects of the invention, which should be considered in all its novel aspects, will become apparent from the following description.

### DRAWING DESCRIPTION

A number of embodiments of the invention will now be described by way of example with reference to the drawings in which:

FIG. 1 is a process diagram illustrating generation of electricity using a dielectric elastomer generator according to the prior art;

FIG. 2 is a block diagram of an active converter, such as a switched-mode power supply, according to the prior art;

FIG. 3 is a block diagram of a uni-directional passively-switched converter of the present invention;

FIG. 4 is schematic of a first embodiment of a passively-switched uni-directional converter according to the present invention, comprising a spark gap as the passive switching circuit;

FIG. 5 is a schematic of a second embodiment of a passively-switched converter according to the present invention;

FIG. 6 is a schematic of a third embodiment of a passively-switched converter according to the present invention;

FIG. 7 is a waveform diagram illustrating the input voltage waveform Vᵢₙ of the passively-switched converter of FIG. 6, when used in conjunction with a self-priming DEG according to the prior art;

FIG. 8 is a waveform diagram illustrating the capacitance of the DEG, Cᵢₙ of the converter of FIG. 6 when used in conjunction with a self-priming DEG according to the prior art;

FIG. 9 is a detailed view of the waveform of FIG. 7, for 10<t<11 s;

FIG. 10 is a waveform diagram illustrating the voltage V_{c1} of the buffer capacitor C₁ of the converter of FIG. 6 when used in conjunction with a self-priming DEG according to the prior art;

FIG. 11 is a waveform diagram illustrating the current I_{Lp} through the primary winding Lₚ of the converter of FIG. 6 when used in conjunction with a self-priming DEG according to the prior art;

FIG. 12 is a schematic of a fourth embodiment of a passively-switched uni-directional converter according to the present invention, comprising a thyristor and an avalanche diode as the passive switching circuit;

FIG. 13 is a schematic of a fifth embodiment of a passively-switched uni-directional converter according to the present invention, comprising a breakover diode as the passive switching circuit;

FIG. 14 is a schematic of a sixth embodiment of a passively-switched uni-directional converter according to the present invention, in which the converter circuit comprises an inductor with a reverse blocking diode and a freewheeling diode;

FIG. 15 is a schematic of a first embodiment of a bi-directional converter according to the present invention;

FIG. 16 is a schematic of the embodiment of FIG. 15 in a DEG system, coupled to a DEG and self-priming circuit;

FIG. 17 is a schematic of the effective circuit of the system of FIG. 16 when converting power in a first direction, from the DEG to the storage capacitor C_{storage};

FIG. 18 is a schematic of the effective circuit of the system of FIG. 16 when converting power in a second direction, from the storage capacitor C_{storage} to the DEG, to prime or re-prime the DEG;

FIG. 19 is a schematic of a further example embodiment of a passive converter according to the present invention;

FIG. 20 is a schematic of a variation of the embodiment of FIG. 19, in which the low voltage load capacitor is coupled to a supply voltage to charge the low voltage capacitor C_{L} to an initial value to increase efficiency;

FIG. 21 is a schematic of a further variation of the embodiment of FIG. 19, in which the converter is coupled directly to a battery which is charged by the DEG;

FIG. 22 is a schematic of a constant charge harvesting circuit including two passive converters according to the embodiment of FIG. 19;

FIG. 23 is a schematic of the same charge harvesting circuit of FIG. 22, modified to charge batteries rather than capacitors;

FIG. 24 is a schematic of a circuit or DEG system for harvesting energy from DEGs to power resistive or joule heaters.

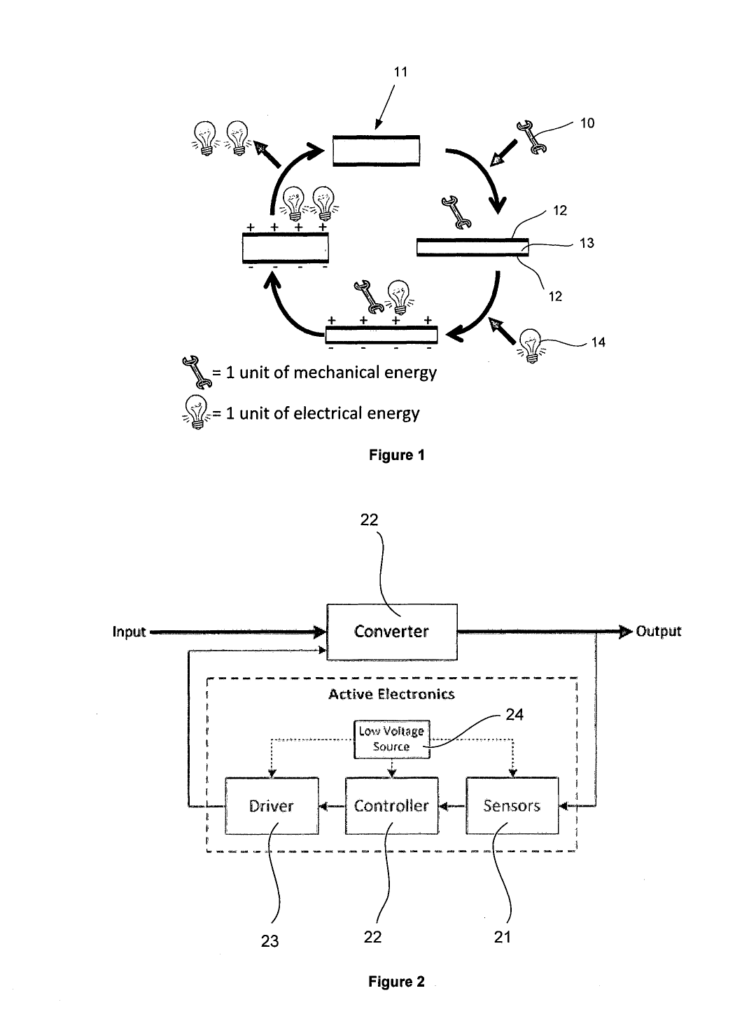

### DETAILED DESCRIPTION OF THE DRAWINGS

Various active DC-DC converter designs are widely used in many applications for their high efficiency and/or ability to regulate the output. In much of modern technology, a passive DC-DC converter isn't very useful because it cannot produce a constant voltage or current to power devices. A passive DC-DC converter wouldn't typically be used for charging a battery from an ideal and unlimited power source, for example, as the output would normally be controlled to maximize the rate and efficiency at which the battery is charged.

The present invention provides a passive converter which particular suited for use as a voltage converter coupled to a limited-energy, low-power DC sources. A limited-energy power source in this context is a power source which cannot supply power continuously. For the purposes of the following description, a limited-energy source may be thought of as being equivalent to a small capacitor with a small amount of stored energy, where the voltage will drop rapidly if energy is drawn from it. That is, power is available only intermittently due to the cyclical nature of a generation process and/or intermittent or unpredictable application of mechanical energy, for example.

Although the following description refers to a dielectric elastomer generator (DEG) as the preferred limited-energy, low-power DC source, it will be appreciated by those skilled in the art that the invention could potentially be used with any alternative source having similar characteristics, without departing from the scope of the invention. More particularly, the DEG represents a high-voltage, low-power DC source and preferred embodiments of the invention will be described below in this context, comprising a step-down transformer for converting the high voltage input to a low voltage output. It is to be appreciated that the invention may alternatively be configured to step-up the input voltage to a higher output voltage by substituting a step-up transformer for the step-down transformer, for example. Alternatively, the circuit need not necessarily modify the magnitude of the input voltage at all, but may simply passively couple the input to the output (e.g. using a transformer with a 1:1 turns ratio). It is also to be appreciated that an inductor could be used in place of the transformer in the converter circuit as a means of transferring and/or converting energy from the input to the output, as described in further detail below with respect to several example embodiments.

The terms “low voltage” and “high voltage”, in the context of DEG, refer to voltages of up to approximately 24 V and at least approximately 500 V, respectively. However, this should not be taken as excluding application of the invention to other voltages or voltage ranges.

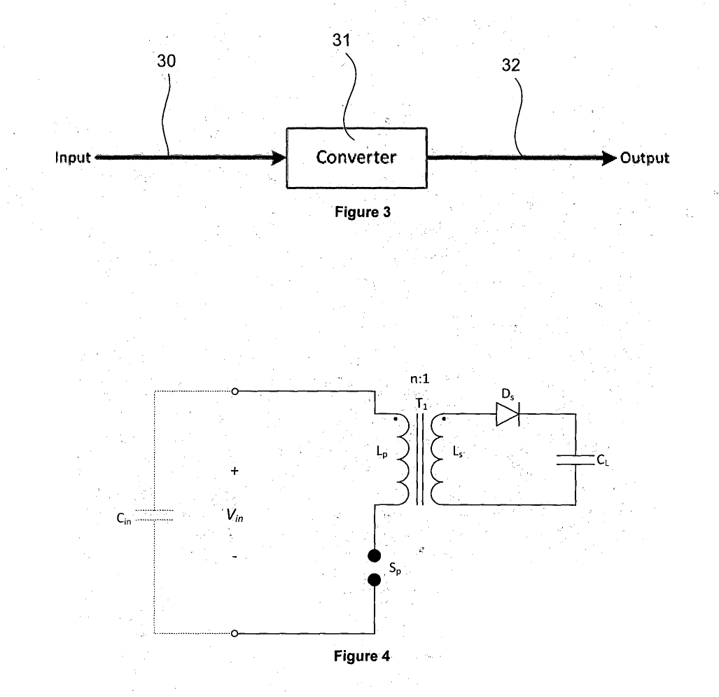

For comparison with the actively-switched converter of the prior art shown in FIG. 2, the present invention is illustrated in block diagram form in FIG. 3. The converter of the present invention comprises an input 30, a conversion circuit 31, and an output 32. The conversion circuit 31 couples the input to the output, which in use would typically be connected to a load such as a battery for charging, for example. Additional circuitry (not shown) can be provided at the output to smooth the current delivered to the load, if necessary, as will be apparent to those skilled in the art.

From this figure, it can be seen that the converter of the present invention requires no active control circuitry, and therefore does not require a low-voltage power source to power the sensor 21, controller 22, and driver electronics 23 required in the prior art converter of FIG. 2.

Accordingly, as will become apparent from the following description the converter of the present invention may be said to be a passive converter, as opposed to an active converter. That is, the input voltage directly controls a passive switch that couples the input power source to the converter without an intermediary sensor, driver, or controller. The passive switch or switching circuit automatically toggles to a “closed” (i.e. conducting) state when the input rises to and exceeds a first threshold, and toggles back into the open (i.e. non-conducting) state when the input falls below a second threshold. Alternatively, or additionally, a passive converter in this context may be defined as one that has no fixed energy costs associated with its functioning, and is self-operating using a small fraction of the power directly from the power source as the conversion process is in operation (attributed to losses due to leakage currents and resistance of non-ideal components in the switching circuit, for example). The passive converter thus does not require a secondary power source or sensing/control signals (aside from a passively-generated control signal in at least one embodiment).

Referring to FIG. 4, a schematic of a first embodiment of a conversion circuit 31 according to the present invention is shown. The switching circuit 31 is shown coupled at its input to a dielectric elastomer generator (DEG) represented by the capacitor Cᵢₙ, and at its output to a capacitive load represented by the capacitor C_{L}.

In this embodiment, the conversion circuit comprises a transformer T₁ having a primary winding Lₚ coupled to a passive switching circuit. In this embodiment, the passive switching circuit comprises the spark gap Sₚ in series with the primary winding Lₚ.

The transformer T₁ preferably has a secondary winding coupled to the output via diode D₃. Additional circuitry (not shown) such as a full-wave rectification diode network could alternatively be used to couple the secondary winding to the output to deliver current to the load in the event the secondary winding becomes negatively polarised, as will be apparent to those skilled in the art.

Alternatively, other rectification topologies, such as a centre-tapped secondary winding coupled to the output via rectification diodes, for example, could be used without departing form the scope of the invention.

Initially, with only a small voltage Vᵢₙ on the capacitor Cᵢₙ the spark gap Sₚ operates as an open circuit preventing current flowing through the primary winding Lₚ.

When the input voltage exceeds a first threshold (in this case the breakdown voltage of the spark gap, e.g. approximately 1 kV), the spark gap Sₚ will break down and conduct current. That is, ionized air creates a conductive path across the gap which drastically reduces the electrical resistance of the gap.

Once the spark gap Sₚ breaks down, a low-resistance conducting path is formed and the input is coupled to the primary winding Lₚ. The spark gap Sₚ will cease conducting once the input falls below a second threshold; in this case, the current through the spark gap falling below the holding current of the spark gap.

While current is conducted through the spark gap Sₚ, the capacitor Cᵢₙ is discharged through the primary winding Lₚ represented by the inductance Lₚ. This induces a positive voltage in the secondary winding Lₛ₁ which charges the capacitive load C_{L}. The output voltage will depend largely upon the first threshold (e.g. the breakdown voltage of the spark gap Sₚ) and the turns ratio n of the transformer T₁. The breakdown voltage of the spark gap depends, for example, upon the gap (i.e. distance), the gas between the electrodes, and the geometry of the electrodes.

When the capacitor C₁, is fully discharged, the energy stored in the transformer T₁ will cause current to continue to flow through the primary winding Lₚ and the spark gap Sₚ. This will charge the capacitor Cᵢₙ to a negative voltage. A negative voltage will also be induced at the secondary winding, which can be used to further charge the load C_{L} if a full wave rectification circuit is used to couple the secondary winding to the output.

Once the transformer T₁ has released all of its stored energy, current flow through the primary winding Lₚ will cease and the spark gap Sₚ will enter a non-conducting, open circuit state.

The capacitor Cᵢₙ is charged negatively at the end of the cycle which may cause problems to the operation of the DEG. However, this negative voltage Vᵢₙ could be utilised by treating the DEG as a re-primed DEG ready to generate a greater negative voltage. In that case, a mirrored converter would be required to convert the negative voltage for supply to the load, C_{L}.

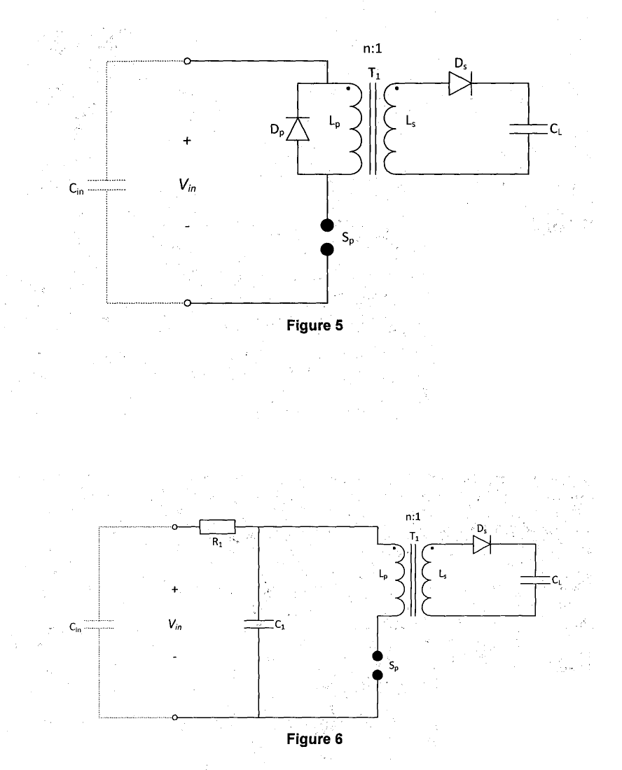

Alternatively, the negative voltage can be substantially prevented. For example, a recirculation diode Dₚ may be provided in parallel with the primary winding Lₚ, as shown in FIG. 5, to recirculate and “burn” off any energy stored in the transformer T₁, through the primary winding Lₚ.

A further potential application of the circuit of the present invention will be described below with reference to a self-priming circuit for DEGs as disclosed in International Publication No. WO 2011/005123 entitled “Transformer and priming circuit therefore”. The self-priming circuit disclosed therein can passively boost the voltage of the DEG from repeated mechanical oscillations. A small initial voltage of a few volts can be boosted to a few kilovolts. This eliminates the need for high-voltage electronics to provide an initial high-voltage charge. However, energy must be extracted from the DEG when the voltage rises too high, to avoid dielectric breakdown.

The converter circuit described above with reference to FIGS. 4 and 5 completely discharges the input capacitor, which is undesirable for a self-priming DEG. This problem can be ameliorated by a buffer circuit between the DEG and the converter that prevents Cᵢₙ from fully discharging. For example, in FIG. 6 an RC (resistor-capacitor) network is used as a buffer between the DEG and the converter to prevent Cᵢₙ from fully discharging. The buffer resistor R₁ slows the rate at which buffer capacitor C₁ is charged from the DEG, again represented by the capacitor Cᵢₙ. Once C₁ is charged to the first threshold voltage, C₁ is fully discharged through the transformer T₁, while Cᵢₙ remains largely unaffected. The spark gap Sₚ will then return to its non-conductive state, allowing C₁ to charge up again. This allows the DEG to generate energy more effectively as it is operating at higher voltage.

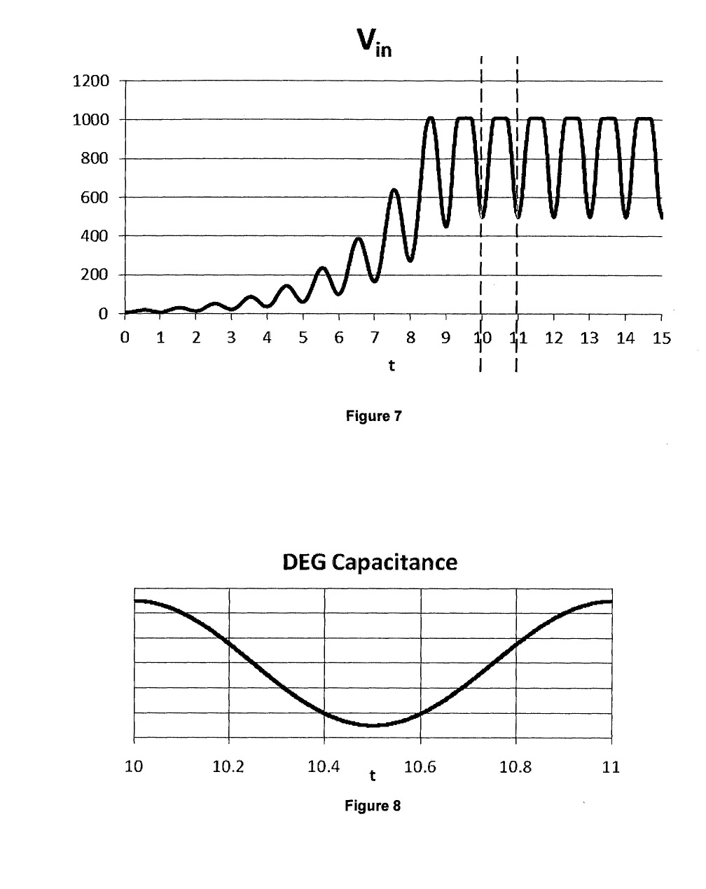

FIG. 7 illustrates an input voltage Vᵢₙ waveform for this circuit connected to a DEG with a self-priming circuit, mechanically oscillated at a frequency of 1 Hz. The self-priming circuit passively increases the voltage Vᵢₙ on the DEG over a number of cycles. The step-down converter of the present invention then draws energy from the DEG whenever Vᵢₙ rises above a first threshold, preventing the voltage from going above approximately 1 kV. The converter is decoupled when the input voltage Vᵢₙ falls below a second voltage, in this case approximately 500V, allowing the DEG to recharge.

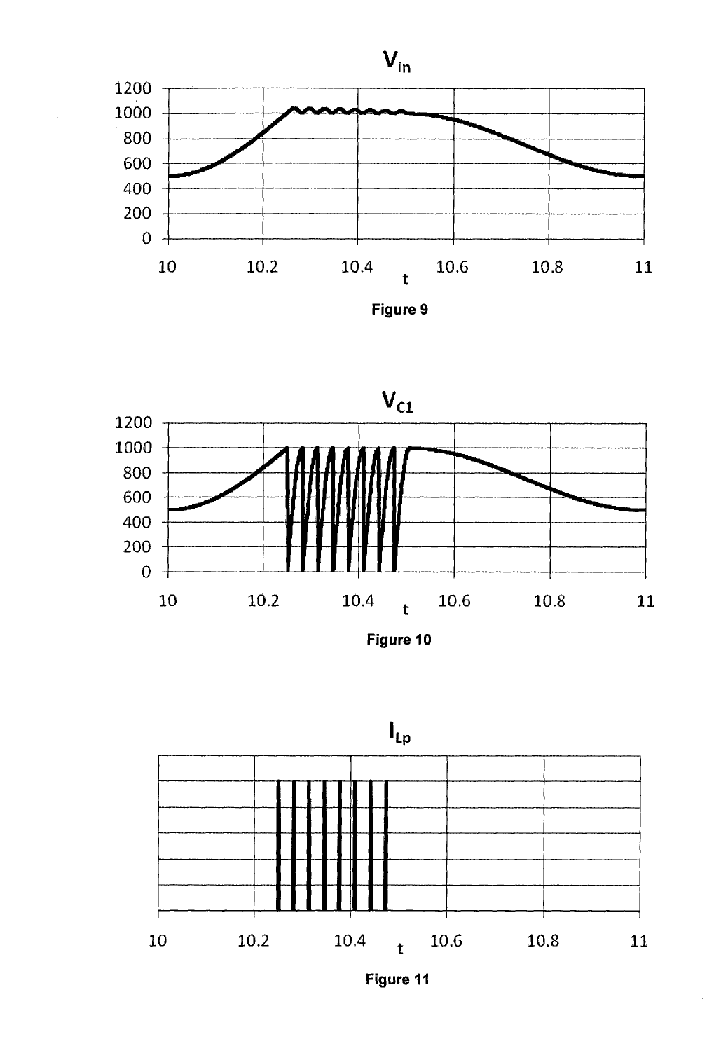

The simplified illustrative waveforms of FIGS. 8-11 further illustrate the operation of the circuit of FIG. 6. FIG. 8 shows the capacitance of the DEG, Cᵢₙ; FIG. 9 shows the input voltage or voltage of the DEG, Vᵢₙ; FIG. 10 shows the voltage of the buffer capacitor C₁, V_{c1}; and FIG. 11 shows the current through the primary winding Lₚ, hₚ. From these figures, it can be seen that when V_{c1} rises above 1 kV, the circuit discharges C₁ through Lₚ in the form of a current pulse which creates a low voltage (assuming a step-down transformer is used) pulse at the output. The input voltage Vᵢₙ is not affected significantly due to the resistor R₁ in the buffer. Once the current through spark gap Sₚ drops below the spark gap's holding current, the passive switch (spark gap Sₚ) turns off and C₁ begins to re-charge again. This repeats until the DEG capacitance stops decreasing.

Although the embodiments of the invention described above utilize a spark gap as a passive switching element, alternative passive switching elements or circuits are possible without departing from the scope of the invention.

A suitable passive switch ideally begins conducting when the voltage across it rises above a certain threshold. This acts as a self-trigger to begin the energy transfer, and would also provide a passive over-voltage protection for the DEG to avoid dielectric breakdown. The switch would also stop conducting when the current flowing through (or the voltage across it) it falls below a second threshold. To minimize losses, the switch should have low leakage current when it is in a non-conductive state, and have a low voltage drop when it is in a conductive state. Switching speed should be significantly faster than the time it takes for Cᵢₙ to fully discharge. Ideally, the first threshold should be higher than the second threshold, whereby the converter has the property of hysteresis so that the switching element or circuit continues to conduct when the voltage falls below the first threshold but not the second.

There are a number of elements and/or configurations which can be used as the passive switch or switching circuit. In addition to the spark gap configuration described above, other suitable passive switches include breakover diodes, discharge tubes, spark gaps, and thyristors with floating gate terminals used as breakover diodes.

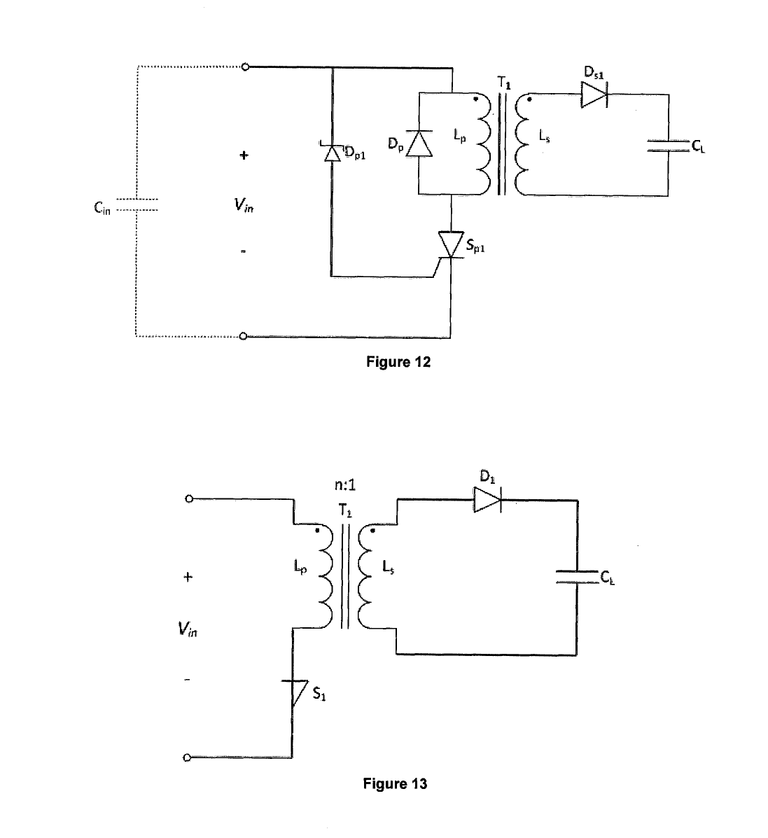

For example, FIG. 12 illustrates an alternative embodiment of the invention comprising a combination of a thyristor Sₚ₁ and an avalanche diode Dₚ₁, where the avalanche diode connected between the positive terminal of Cᵢₙ (or C₁ if a buffer is used) and the gate of the thyristor Sₚ, is used as a passive switch to passively control the thyristor. When the voltage across the avalanche diode reaches a first threshold the avalanche diode breaks down and allows current to flow into the gate of the thyristor, thereby triggering the thyristor to enter the conductive “ON” state. The avalanche diode Dₚ₁ will cease conducting once the reverse voltage drops below the first threshold voltage. However, the thyristor Sₚ₁ will continue to conduct in the forward direction until the input falls below the second threshold. In this case, the second threshold is the holding current (e.g. 5 mA) of the thyristor.

A spark gap may be preferable over the thyristor and avalanche diode configuration in some cases due to its low cost and low leakage current. In other applications, the thyristor configuration, either with the avalanche diode or a floating gate terminal, may be preferred to reduce electromagnetic noise and/or improve repeatability, for example.

A further alternative converter circuit according to the present invention, incorporating a breakover diode in series with the input and the primary winding Lₚ as the passive switching circuit, is shown by way of example in FIG. 13.

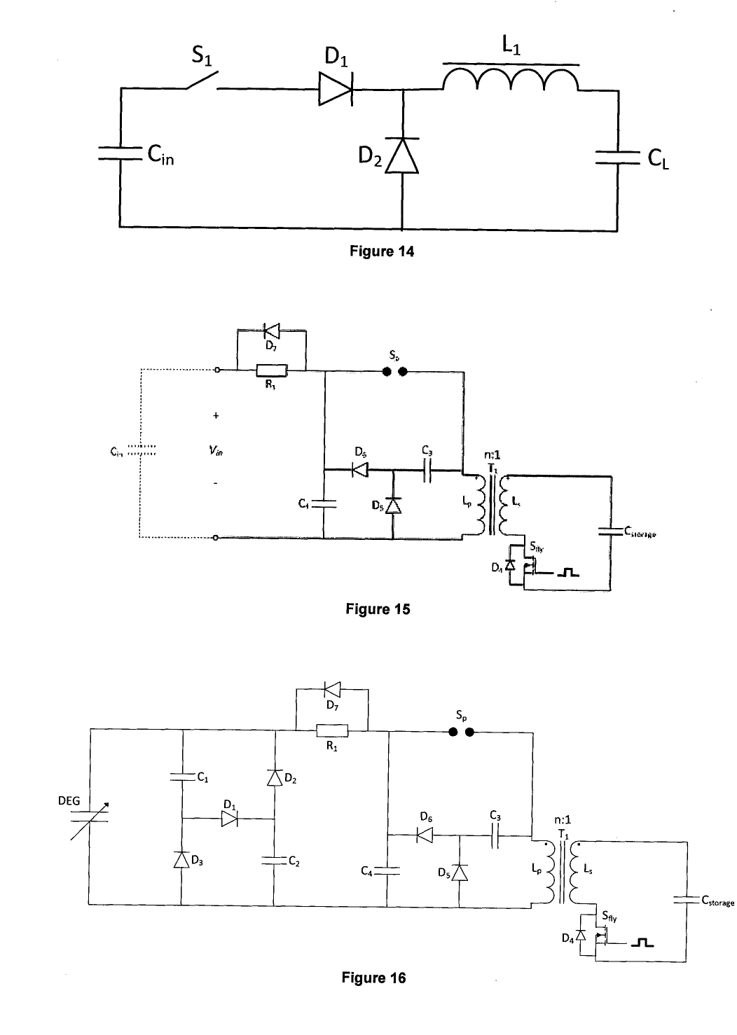

Yet another alternative converter circuit according to the present invention, incorporating a conversion circuit based on an inductor rather than a transformer, is shown by way of example in FIG. 14. The passive switching element S₁ (represented in this schematic by a standard mechanical switch symbol, but which may comprise any of the aforementioned or equivalent passive switches) couples the input Cᵢₙ to the inductor L₁ when the input voltage reaches a first threshold. Energy is stored in inductor L₁, which is released to the output C_{L} at the desired voltage. Reverse blocking diode D₁ prevents energy being returned to the input Cᵢₙ from the converter circuit. Freewheeling diode D₂ prevents a large negative voltage spike appearing across inductor L₁ when the passive switch ceases to conduct.

Other possible applications of the passively-switched uni-directional converter of the present invention include using the converter as a voltage threshold detector by generating a low or high voltage pulse when the input voltage exceeds the first threshold; for recovering energy used to actuate a dielectric elastomer actuator (DEA), which is usually wasted; and transferring energy between two DEAs/DEGs.

The uni-directional passive converter of the present invention may also be combined with a second converter to create a bi-directional converter, if required. The bi-directional converter thus comprises a passive converter combined with an active converter. The active converter preferably comprises a rectifier, which may comprise a voltage multiplier.

As the converter is bi-directional, the terms “primary” and “secondary” may be applied arbitrarily to the two windings of the transformer, or dependent upon the direction of power conversion. For the purpose of the following description, however, the terms are applied consistently with the description of the preceding uni-directional converter embodiments of the invention.

An example embodiment of a bi-directional converter according to the present invention is shown in FIG. 15. The bi-directional converter comprises the passive uni-directional converter embodiment of FIG. 6, together with additional components comprising diodes D₅, D₆, and D₇; capacitor C₃ and controllable switch S_{fly}. It will be apparent to those skilled in the art that the additional components in this preferred embodiment form a flyback converter and voltage multiplier with transformer T₁, as described in further detail below. In particular, the transformer T₁, capacitors C₁ and C₃, and diodes D₅ and D₆ in this preferred embodiment form a Greinacher voltage doubling rectifier.

While other types of active converter may alternatively be used without departing from the scope of the invention, the fly-back converter is preferred due to its simplicity and low cost. The spark-gap S, may also be replaced by an alternative passive switch, as discussed above, without departing from the scope of the invention.

A DEG system comprising the preferred embodiment of the bi-directional converter is shown in FIG. 16, coupled to a parallel DEG and single stage self-priming circuit (comprising capacitors C₁ and C₂ and diodes D₁, D₂ and D₃) as disclosed by WO 2011/005123. In this system, the passive converter forms a step-down converter for extracting high-voltage energy from the DEG and supplying it to the storage capacitor, C_{storage}, at a lower voltage. The flyback converter forms a step-up converter to prime the DEG by stepping up the voltage across storage capacitor C_{storage} and supplying high-voltage electrical energy to the DEG and the self-priming circuit.

Although the bi-directional converter is shown coupled to a storage capacitor C_{storage} by way of example, the converter may alternatively or additionally be coupled to any component or circuit for supplying energy to the DEG and/or using energy generated by the DEG.

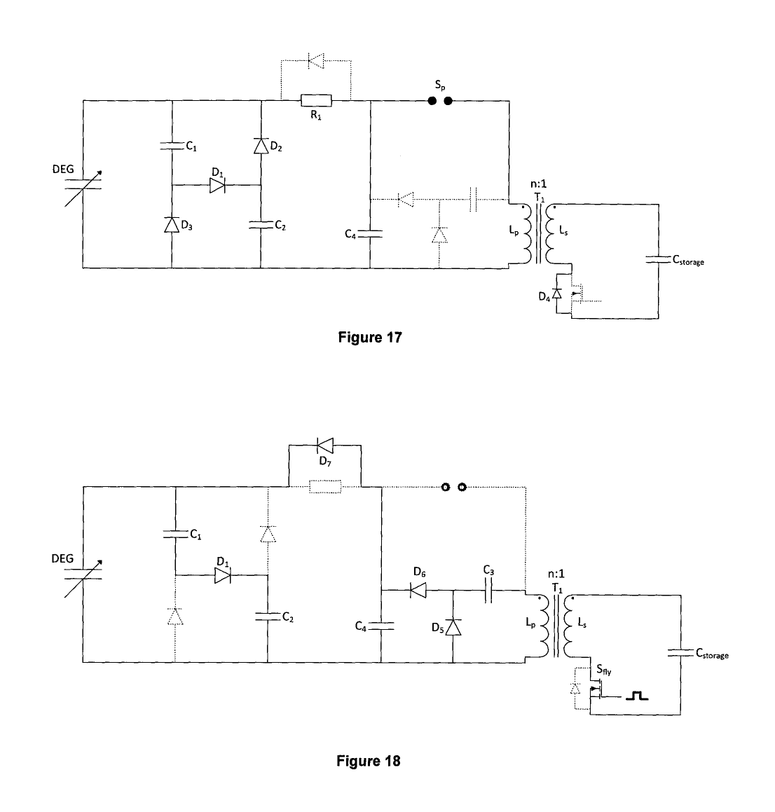

Operation of the system of FIG. 16 is further illustrated in FIGS. 17 and 18. FIG. 17 shows the effective circuit when the passive step-down converter extracts electrical energy from the DEG. As previously described with respect to FIG. 6, resistor R₁ and capacitor C₄ form a buffer between the DEG and passive step-down converter to prevent the DEG from fully discharging. Once the buffer capacitor C₄ is charged to the first threshold voltage, it is fully discharged through spark gap Sₚ and transformer T₁ to charge the storage capacitor C_{storage} while the DEG remains largely unaffected. The spark gap Sₚ will then return to its non-conductive state, allowing buffer capacitor C₄ to charge up again.

Diode D₆ is reverse-biased and diode D₄ is forward-biased when the converter operates in this first direction, and the additional flyback converter and voltage multiplier components thus do not affect operation of the passive step-down transformer described above.

FIG. 18 shows the effective circuit when the flyback converter is used to prime the DEG (i.e. when electrical energy is transferred in the opposing, second, direction). The controllable flyback switch S_{fly} is driven by a square-wave signal to selectively discharge the storage capacitor C_{storage} through the secondary winding Lₛ of the transformer T₁.

The square-wave signal may be produced by an astable mutivibrator or a microcontroller, for example. The frequency and duty cycle of the signal are preferably fixed, and the circuit designed to output a predetermined number of pulses/oscillations to charge the DEG up to a desired voltage.

When the switch S_{fly} is closed, current increases through the secondary winding Lₛ, increasing the magnetic flux in the transformer and inducing a voltage in the primary winding Lₚ. The voltage induced in the primary winding Lₚ is stepped up by the turns ratio n:1 of the transformer T₁ (where n is the number of turns of the primary winding Lₚ for each turn of the secondary winding Lₛ). Diode D₆ is forward-biased, and the secondary winding current thus charges capacitors C₃ and C₄ to half of the voltage induced in the primary winding Lₚ (assuming an ideal circuit). Diode D₅ is reverse-biased.

The voltage induced in the primary winding Lₚ when switch S_{fly} is closed in relatively insignificant, however. A much higher voltage is produced from the magnetic energy stored in the transformer when switch S_{fly} is subsequently opened.

When the switch S_{fly} opens after conducting for a short period, the storage capacitor C_{storage} is decoupled from the secondary winding L₃. A finite amount of current is flowing through the secondary winding L₃ prior to this, which is related to the amount of magnetic energy stored in the transformer. The instantaneous decoupling of the secondary winding L₃ induces a large voltage (an infinitely large voltage if there is no load and the components are ideal) across both the secondary winding L₃ and the primary winding L₂ in the reverse polarity. Diode D₅ become reverse-biased, and diode D₆ becomes forward-biased. The energy stored in the transformer will be transferred to C₃ in a high voltage form. The voltage reached will be determined by how much energy was stored in the transformer (i.e. how much current is flowing though the secondary winding) when the switch opens.

When the reverse voltage induced by the energy stored in the transformer diminishes to 0V, the voltage of C₃ will reverse-bias diode D₆ and forward-bias diode D₅. Energy stored in C₃ will be transferred to C₄, charging it to a high voltage. If this voltage is greater than the voltage of the DEG, diode D will be forward-biased and the DEG will be charged.

The DEG system may further include a priming switch for manual operation by the user of the system to re-prime the DEG after it has been discharged through leakage after a long period of non-use. Thereafter, power generation and conversion will occur without any further intervention. Alternatively, the system may be configured to automatically detect oscillation of the DEG and automatically trigger a one-off re-priming of the DEG, using known self-sensing techniques for example. However, this would consume more power.

In any converter requiring one or more transformers, the transformers are invariably the largest and heaviest component of the converter. The bi-directional converter of the present invention, and a DEG system comprising the bi-directional converter, uses a single transformer for both stepping down a voltage in a first direction, and stepping-up a voltage in a second, opposing direction, thus achieving significant size and weight savings over the prior art which may require two transformers.

The bi-directional converter of the present invention, with a passive converter and only a single active converter, is also relatively simple with only minimal control requirements. This minimizes the cost and size of the system, so it can be used in small portable energy scavenging devices, for example. The bi-directional converter thus enables a relative simple and low-cost self-priming dielectric elastomer generator system without the need for an external priming source. That is, electrical energy generated by the DEG and required for priming the DEG can be respectively supplied to and sourced from the same circuit coupled to the secondary side of the transformer (which may comprise a simple storage capacitor, for example).

The present invention is also compatible with self-sensing circuits which may be used to obtain feedback regarding the electrical and/or mechanical properties of the DEA without external sensors. In particular, charging and/or discharging of the DEG using the passive and/or bi-directional converter of the present invention causes changes in voltage and current flow which can be measured to derive an estimate of the state of the DEA as disclosed by International Patent Publication No. WO 2010/095960, for example.

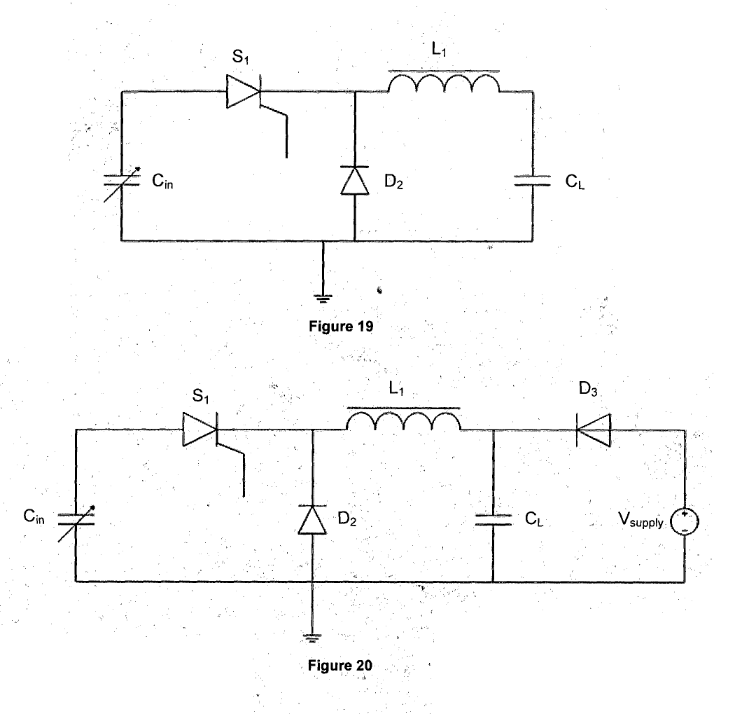

FIG. 19 illustrates another embodiment of a passive uni-directional converter according to the invention, similar to that of FIG. 14. In this example, the converter again comprises an inductor L₁ rather than the transformer of other embodiments. The variable capacitor Cᵢₙ represents a DEG, and the capacitor C_{L} is preferably a large low-voltage capacitor. In this embodiment, however, the passive switching element S₁ comprises a breakover diode, and the reverse blocking diode D₁ of FIG. 14 is therefore omitted.

The inductor L₁ needs to be large enough to limit the current in the converter when the DEG discharges, and should be tuned to the DEG.

The DEG C₁ is charged when stretched. When it relaxes, the voltage rises. Once the

DEG voltage reaches the breakover voltage of the breakover diode S₁, the diode switches on and conducts until the DEG is discharged. The capacitor C_{L} is charged a small amount, but more crucially magnetic energy is stored in the inductor L₁. Once the DEG is discharged the magnetic energy in the inductor L₁ causes current to flow through the bypass diode D₂ and into the capacitor C_{L}. In an ideal system energy is conserved so the low voltage capacitor C_{L} will eventually contain all the energy from the DEG. In reality, there are losses in the circuit so not all of the energy will transfer. Early prototypes have shown that over half of the energy can be transferred, however, and it is expected that greater efficiency can be achieved with careful design and component selection.

This circuit is thus capable of achieving efficient transfer of energy from a high voltage capacitor such as a DEG to a low voltage storage capacitor using as few as three components (breakover diode, bypass diode, and step-down inductor). The converter automatically triggers when a threshold voltage is reached, and makes use of a capacitive instead of inductive step down to reduce the required size of the inductive component. It also works well with a high leakage current diode. Because of the low number of components as well as relaxed requirements on their performance the circuit is a compact and a relatively inexpensive way to effectively step down energy in a portable generator device.

FIG. 20 illustrates a variation of the embodiment of FIG. 19, in which the converter circuit is coupled to a supply voltage, which can be used to charge the low voltage capacitor C_{L} to an initial value to increase efficiency. Efficiency of the converter is in part determined by the ratio of the output capacitor C_{L} voltage to the loss voltages due to the diodes and other parasitic resistances.

FIG. 21 is another similar variation of the embodiment of FIG. 19, in which the converter is coupled directly to a battery V_{battery}, which is charged by the DEG while also potentially supplying power to another circuit or component via the output terminal, Vₒᵤₜ. Depending upon the internal resistance of the battery, some kind of battery/capacitor combination may be needed to accept the high current the converter will supply.

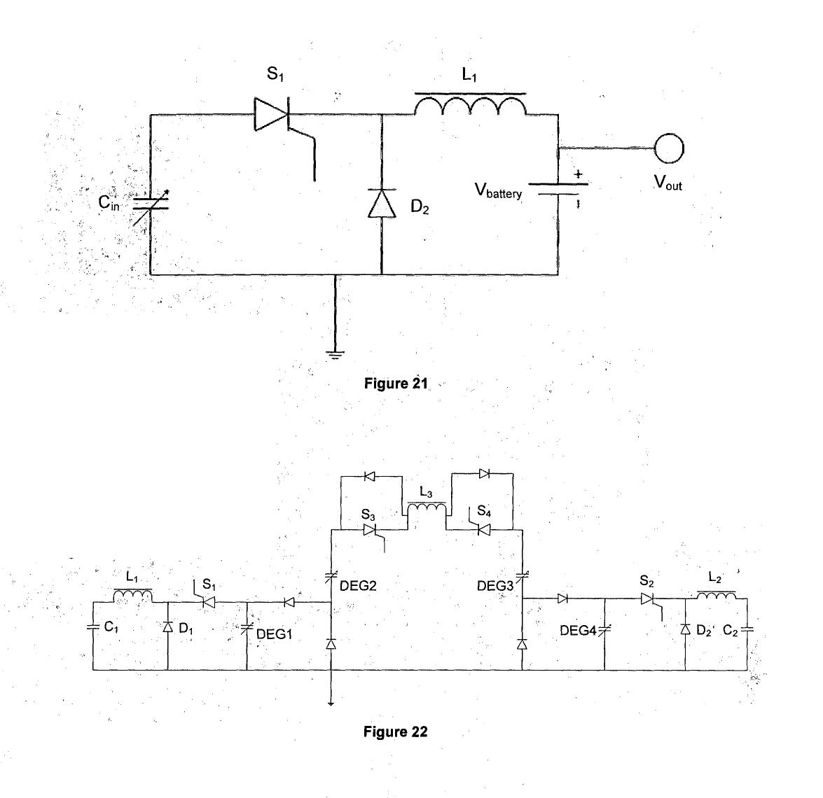

An example application of the converter of FIG. 19 is provided in the schematic of FIG. 22, in the form of a constant charge harvesting circuit. The circuit comprises four dielectric elastomer generators (DEG1-DEG4) and two converters according to the present invention (comprising L₁, D₁, and S₁ coupled to DEG1; and L₂, D₂, and S₂ coupled to DEG4, respectively).

In this circuit DEGs 1 and 2 are physically arranged to be out of phase with DEGs 3 and 4. That is, DEGs 1 and 2 move from a low capacitance to a high capacitance at the same time as DEGs 3 and 4 move from a high capacitance to a low capacitance. The difference in capacitance should be greater than a factor of two for the circuit to work.

When DEGs 1 and 2 are both charged in the high capacitance state, DEGs 3 and 4 are in the low capacitance state and have no charge on them. As the generator deforms DEG 1 and 2 both relax towards the low capacitance state and the voltage on them goes up. At some point the voltage exceeds that of breakover diodes S₁ and S₂, and DEG1 discharges into the low voltage output capacitor C₁. DEG2 discharges into DEG3 and DEG4 which are in a series configuration. The central inductor L₃ ensures efficient and full charge transfer. The direction of the generator deformation is then reversed and the cycle continues. This harvester can be seen as a central pair of DEGs which pass a packet of high voltage charge back and forward, every time outputting an equal or greater sized package of charge to the step-down converters. The step-down converter circuits boost the energy of the charge packet before stepping it down. In this way the generator follows a highly effective constant charge cycle without the need to re-prime the DEGs from low voltage or without the need for limit switches, active switches, microcontrollers, or protection circuits. That is, the energy harvesting circuit takes advantage of the step down circuit as well as breakover diodes of the passive converter in such a way that they act as both energy transfer mechanisms as well as deformation sensors (when coupled to the DEG).

The circuit of FIG. 22 thus harvests energy from four dielectric elastomer generators operating in pairs and counter phase. The circuit uses a constant charge cycle with the key distinction that the re-priming charge for the generator is stored in a high voltage form. This improves the efficiency of the system as most losses are introduced in the conversion between high and low voltage energy. A major advantage of this circuit is that it works entirely without the need for active switching, sensing and control. This makes it more compact, inexpensive, and efficient than low power harvesting circuits of the prior art, and thus better suited to portable power generation.

This circuit can also be modified by replacing one side with a single DEG to eliminate an inductor.

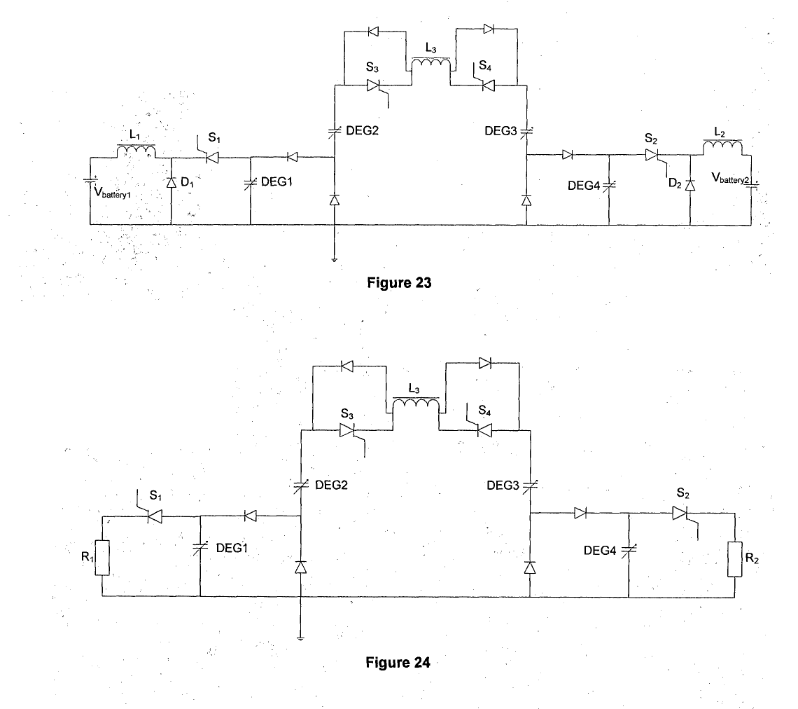

Rather than converting energy for storage by output capacitors C₁ and C₂, the converters may alternatively be adapted to charge batteries V_{battery1} and V_{battery2}, as shown in FIG. 23 for example.

The circuits of FIGS. 19-23 (and potentially other embodiments of the invention described previously) may be used for the effective generation of power from artificial muscle or dielectric elastomer generators in smart apparel or distributed sensors, for example. Particular applications might include range extenders for cell phones; self-powered medical monitors; or heated, cooled, adapting, or illuminated footwear, for example.

FIG. 24 illustrates a particular embodiment of a circuit according to the invention which may be used to power resistive heaters R₁ and R₂, for example. The resistive joule heaters replace the output capacitors C₁ and C₂. This heater circuit uses the harvesting circuit of FIG. 22, but instead of stepping the power down it is converted directly to heat. The step-down sections of the circuit of FIG. 22, comprising the inductors L₁ and L₂ and freewheel diodes D₁ and D₂, are therefore omitted. This is an elegant way to create a heat generator for a shoe or other actively warmed apparel, for example. Again, there is no need for active control, sensing, or switches.

This example circuit provides a compact and efficient means of generating heat from a DEG (provided in a shoe heel to generate energy by deforming upon a heel strike during walking or running, for example), with the added bonus that losses simply create more heat.

Aside from the differences noted, the circuits of FIGS. 23 and 24 otherwise operate similarly to that of FIG. 22, as described in further detail above.

In further embodiments the invention provides a passive converter circuit for a time varying power supply. The time-varying power supply has a time characteristic. The reader will be aware of various time characteristics for various applications. For example, the application may be DEGs which is stimulated with a characteristic average period. The DEG may be designed for use for energy scavenging from the walking motion of a population of people, and there may be a characteristic force and/or period of footfall. The DEG output may also have a characteristic capacitance or range of capacitances and a characteristic time-constant for the DEG discharging through the converter circuit. Further examples of time characteristics, or parameters, will be apparent to the reader.

In yet further embodiments, the passive converter includes an inductance in series with a capacitance associated with a load or power storage device. The inductance and/or the capacitance can be selected for a time-characteristic of the power supply so that the voltage across the load or power storage device is at a given voltage or in a range of voltages. In one embodiment, the voltage is determined by the inductance, capacitance and a time parameter of the supply signal. As understood by the reader solving for current, being the same through the devices in series, will determine a suitable inductance or capacitance, or combination, for a given voltage or range of voltages. These embodiments take advantage of the time-varying characteristics of the supply to use a low complexity converter circuit.

In further embodiments, the circuits described herein are provided with a passive switch to discharge the high voltage on a DEG to prevent build-up of charge preventing voltages across diodes from being sufficient to cause breakover or other effects in the diode. These switches may be configured for given applications to switch occasionally, such as when a foot strikes harder than on average by some margin.

From the foregoing it will be seen that a passively-switched converter is provided which offers significant advantages over actively-switched converters of the prior art in converting energy from limited-energy, low-power DC sources. In particular, the converter requires no external or parasitic power supply for active components, and requires relatively few passive components. The converter is therefore lightweight and inexpensive, and is particularly suited for use with a small-scale dielectric elastomer generator to supply power to a low-voltage load. A bi-directional converter circuit is also provided, combining the passively-switched converter with an active converter in a relatively simple circuit using the same transformer to achieve bi-directional conversion with only minimal control requirements. Novel energy harvesting and heating circuits comprising the passive converter are also disclosed, obviating the need for active control, sensing, or switching.

Although this invention has been described by way of example and with reference to possible embodiments and example applications thereof, it is to be understood that modifications or improvements may be made thereto without departing from the scope of the invention. For example, circuits including the passive converter may be modified by incorporating additional circuitry to avoid over-charging of an output capacitor or battery, and/or or including switches which might be mechanically activated to short the DEG to earth from time to time to prevent charge building up and reducing the voltage across breakover diodes between DEGs. The invention may also be said broadly to consist in the parts, elements and features referred to or indicated in the specification of the application, individually or collectively, in any or all combinations of two or more of said parts, elements or features. Furthermore, where reference has been made to specific components or integers of the invention having known equivalents, then such equivalents are herein incorporated as if individually set forth.

Unless the context clearly requires otherwise, throughout the description, the words “comprise”, “comprising”, and the like, are to be construed in an inclusive sense as opposed to an exclusive or exhaustive sense, that is to say, in the sense of “including, but not limited to”.

Any discussion of the prior art throughout the specification should in no way be considered as an admission that such prior art is widely known or forms part of common general knowledge in the field.

1. A passive converter comprising an input for electrical coupling to an intermittent or variable power source, an output for electrical coupling to load, and a conversion circuit for converting from a first voltage level at the input to a second voltage level at the output, wherein the conversion circuit comprises a passive switching circuit adapted to passively couple the input to the output when the input exceeds a first threshold and decouple the input from the output when the input falls below a second threshold.

2. The passive converter of claim 1, wherein the first threshold comprises a threshold voltage, and the second threshold comprises a threshold current.

3. The passive converter of claim 1, wherein the conversion circuit further comprises a transformer coupling the passive switching circuit to the output.

4. The passive converter of claim 3, wherein the passive switching circuit couples the input to a primary winding of the transformer when the input exceeds the threshold voltage, and a secondary winding of the transformer is coupled to the output.

5. The passive converter of claim 4, wherein the secondary winding of the transformer is coupled to the output via a diode or a full-wave rectifier.

6. The passive converter of claim 4, wherein the secondary winding of the transformer comprises a centre-tapped winding comprising first and second half windings, wherein said first and second half-windings are coupled to the output via a pair of diodes forming a full-wave centre-tapped rectifier.

7. The passive converter of claim 1, wherein the conversion circuit comprises an inductor circuit coupling the passive switching circuit to the output.

8. The passive converter of claim 7, wherein the inductor circuit further comprises a freewheeling diode and a reverse blocking diode.

9. The passive converter of claim 1, wherein the switching circuit comprises a spark gap, whereby the first threshold comprises a breakdown voltage of the spark gap, and the second threshold comprises a holding current of the spark gap.

10. The passive converter of claim 1, wherein the switching circuit comprises a thyristor in series with a primary winding of the transformer, and an avalanche diode connected between a positive terminal of the input and the gate of the thyristor, whereby the first threshold comprises a breakdown voltage of the avalanche diode and the second threshold comprises a holding current of the thyristor.

11. The passive converter of claim 1, wherein the switching circuit comprises a breakover diode coupled with an inductor and a bypass diode, whereby the first threshold comprises a breakover voltage and the second threshold comprises a holding current of the breakover diode.

12. The passive converter of claim 1, wherein the switching circuit comprises a component selected from the group comprising spark gaps, thyristors and avalanche diodes, breakover diodes, discharge tubes, and thyristors operated as breakover diodes.

13. The passive converter of claim 1, wherein the converter further comprises a buffer circuit between the input and the conversion circuit, said buffer circuit comprising an RC network.

14. A bi-directional converter comprising a passive converter according to claim 1 for converting power in a first direction, and an active converter for converting power in a second, opposing, direction.

15. The bi-directional converter of claim 14, wherein the bi-directional converter further comprises a transformer associated with both the passive and active converters.

16. The bi-directional converter of claim 14, wherein the active converter comprises a flyback converter.

17. The bi-directional converter of claim 14, wherein the passive converter comprises a step-down converter, and the active converter comprises a step-up converter.

18. A dielectric elastomer generator (DEG) system comprising at least one DEG electrically coupled to a passive converter according to claim 1.

19. The DEG system of claim 18, comprising two pairs of DEGs adapted to operate in counter phase and two passive converters, wherein each pair of DEGs is provided in series and coupled to the input of one of said passive converters and each pair of DEGs are coupled to each other by an inductor and a pair of breakover diodes.

20. The DEG system of claim 19, wherein the passive converters each comprise a breakover diode as the passive switching circuit.

21. The DEG system of claim 18, wherein the output of the passive converters is coupled to a capacitor, battery, or resistor.

22. The DEG system comprising a DEG electrically coupled to a bi-directional converter according to claim 14.

23. The DEG system of claim 22, further comprising a self-priming circuit in parallel with the DEG and bi-directional converter.

24. The passive converter of claim 1, wherein the passive switching circuit comprises a passive switching element operable to selectively couple the input to the output with no fixed energy cost.

25. The passive converter of claim 24, wherein the passive switching element is directly controlled by the first voltage level.
